(19) United States
(12) Patent Application Publication
(10) Pub. No.: US 2014/0296039 A1
(43) Pub. Date: Oct. 2, 2014

(54) Walker Apparatus

(71) Applicants: Jimmy Wayne Shaw, Rockdale, TX (US); Jewel Marie Shaw, Rockdale, TX (US)

(72) Inventors: Jimmy Wayne Shaw, Rockdale, TX (US); Jewel Marie Shaw, Rockdale, TX (US)

(21) Appl. No.: 13/850,407

(22) Filed: Mar. 26, 2013

(51) Int. Cl. A61H 3/04; A61H 3/00

(52) U.S. Cl. CPC A61H 3/04; A61H 3/00
USPC 482/68; 297/467; 297/5; 135/67; 135/66

(57) ABSTRACT

A walker apparatus includes a framework having upstanding front and rear support members connecting upper and lower sections. The upper section is mounted atop upper ends of respective front and rear support members. The upper section includes a pair of side members each having opposed front and rear ends coupled to respective front and rear support member upper ends. The upper section includes a rear support member extending between rear ends of respective upper section side members. The upper section includes a front support member pivotally coupled at a proximal end to a front support member upper end and releasably coupled to another so as to be movable between open and closed configurations. The apparatus includes a lower section having first and second supports bars each having an outwardly arcuate configuration and positioned so as not to create a trip hazard when the front support member is open.

### BACKGROUND OF THE INVENTION

This invention relates generally to mobility devices and, more particularly, to a walker apparatus that enables a person to walk with less risk of falling, to sit if tired and while eating, and to enter or exit the interior area of the walker without any trip hazards.

Persons who experience decreased mobility often use mobility enhancing devices such as canes, wheelchairs, and walkers. Mobility assistance may be needed by the elderly, persons healing from a leg or back injury, persons with chronic or debilitating conditions such as multiple sclerosis or muscular dystrophy, or persons who may simply get easily disorienting such as one having Alzheimer's disease.

Various devices, including combination strollers and walkers, have been proposed in the art, including those by U.S. Pat. Nos. 5,083,806, 6,527,285, 7,735,499, and 8,104,780. Although assumably effective for their intended purposes, the existing devices do not provide a combination of the most important features and configurations that provide the highest degree of safety and convenience to a user, whether the user is a patient in a hospital, nursing facility, or at home.

Therefore, it would be desirable to have a walker apparatus that minimizes the risk of falling by providing a durable framework that surrounds a patient while walking, lower support bars that strengthen the device, a seat convenient for supporting the patient if tired or unsteady or while eating, a front gate that is operable by the patient such as to enable the patient to exit the walker to use a toilet. Further, it would be desirable to have a walker apparatus that includes optional features such as a pouch to hold a patient's personal or medical items, a tray to use while eating, a compressed gas tank holder, an IV pole holder, and the like.

### SUMMARY OF THE INVENTION

A walker apparatus according to a preferred embodiment of the present invention includes a framework having upstanding front and rear support members connecting upper and lower sections. The upper section is mounted atop upper ends of respective front and rear support members. The upper section includes a pair of side members each having opposed front and rear ends coupled to respective front and rear support member upper ends. The upper section includes a rear support member extending between rear ends of respective upper section side members. The upper section includes a front support member pivotally coupled at a proximal end to a front support member upper end and releasably coupled to another so as to be movable between open and closed configurations. The apparatus includes a lower section having first and second supports bars each having an outwardly arcuate configuration and positioned so as not to create a trip hazard when the front support member is open.

Therefore, a general object of this invention is to provide a walker apparatus that enables a patient to walk, roll, sit to rest or eat, and transfer to and from a toilet with a decreased risk of falling and with an increased sense of convenience and independence.

Another object of this invention is to provide a walker apparatus, as aforesaid, that is configured to enable a user to operate a front gate between open and closed configurations and to enter and exit the apparatus without any trip hazards.

Still another object of this invention is to provide a walker apparatus, as aforesaid, having structures for holding a patient's compressed gas tank, IV pole, and personal items.

Other objects and advantages of the present invention will become apparent from the following description taken in connection with the accompanying drawings, wherein is set forth by way of illustration and example, embodiments of this invention.

### BRIEF DESCRIPTION OF THE DRAWINGS

FIG. 1 is a perspective view of a walker apparatus according to a preferred embodiment of the present invention;

FIG. 2 is a top view of the walker apparatus as in FIG. 1;

FIG. 3 is a side view of the walker apparatus as in FIG. 1;

FIG. 4 is a top view of the walker apparatus with a quick release pin as in FIG. 1;

FIG. 5a is another perspective view of the walker apparatus as in FIG. 1;

FIG. 5b is an isolated view on an enlarged scale taken from FIG. 5a;

FIG. 6 is a top view of a seat as in FIG. 1;

FIG. 7 is a side view of the walker apparatus according to another embodiment of the present invention, shown in a collapsed configuration as in FIG. 1;

FIG. 8 is a perspective view of the walker apparatus as in FIG. 7 in a partially opened or expanded configuration; and

FIG. 9 is a perspective view of the walker apparatus as in FIG. 8 shown in a completed opened or expanded configuration.

### DESCRIPTION OF THE PREFERRED EMBODIMENT

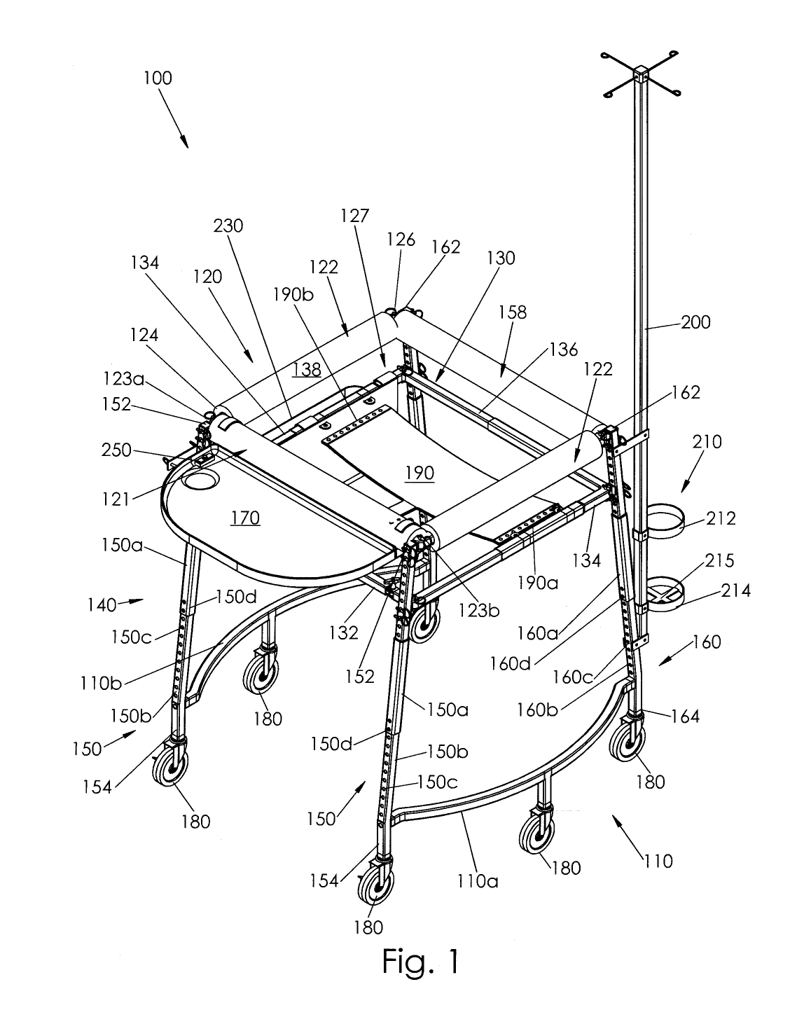

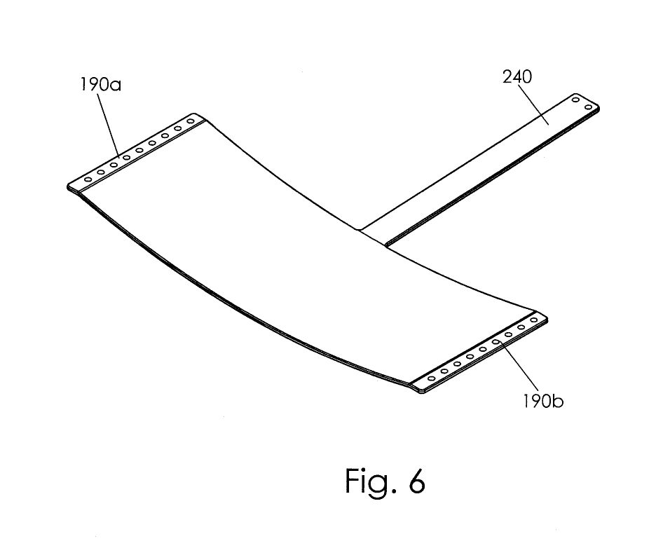

A walker apparatus according to a preferred embodiment of the present invention will now be described with reference to FIGS. 1 to 7 of the accompanying drawings. The walker apparatus 100 includes a lower section 110, an upper section 120, a pair of upstanding front support members 150, and a pair of upstanding rear support members 160.

In one embodiment of the present invention (FIG. 1), the walker apparatus 100 includes a framework 140 having a pair of spaced apart upstanding front support members 150 and a pair of spaced apart upstanding rear support members 160. Each upstanding support member may be length adjustable as will be described later. The pair of spaced apart upstanding front support members 150 each has an upper end 152 and a lower end 154. The pair of spaced apart upstanding rear support members 160 each has an upper end 162 and a lower end 164. The pair of upstanding front support members 150 and the pair of upstanding rear support members 160 are connected at respective lower ends 154, 164 to the lower section 110 and at respective upper ends 152, 162 to the upper section 120 to form the framework 140. The lower ends 154 of the front support members define a void therebetween to as not to form any obstruction to a user as will become apparent later.

The lower section 110 has a first support bar 110a and a second support bar 110b each having an outwardly arcuate configuration extending between a respective front support member 150 and rear support member 160. The support bars 110a, 110b are configured outwardly so as to eliminate a trip hazard to a patient.

The upper section 120 may be mounted atop respective upper ends 152 of said pair of front support members 150 and to respective upper ends 162 of said pair of rear support members 160. More particularly, the upper section 120 includes a pair of opposed side members 122 each extending between respective upper ends 152 of the front support members 150 and upper ends 162 of rear support members 160. Each side member 122 includes a front end 124 coupled to an upper end 152 of a front support member 150 and a rear end 126 coupled to an upper end 162 of a respective rear support member 160. The upper section 120 also includes a rear member 158 coupled to and extending between respective upper ends 162 of the upstanding rear support members 160. Together, the structures described above, taken together, illustrate that the upper section 120 defines an interior area 127 designed to accommodate a patient, as will be described later.

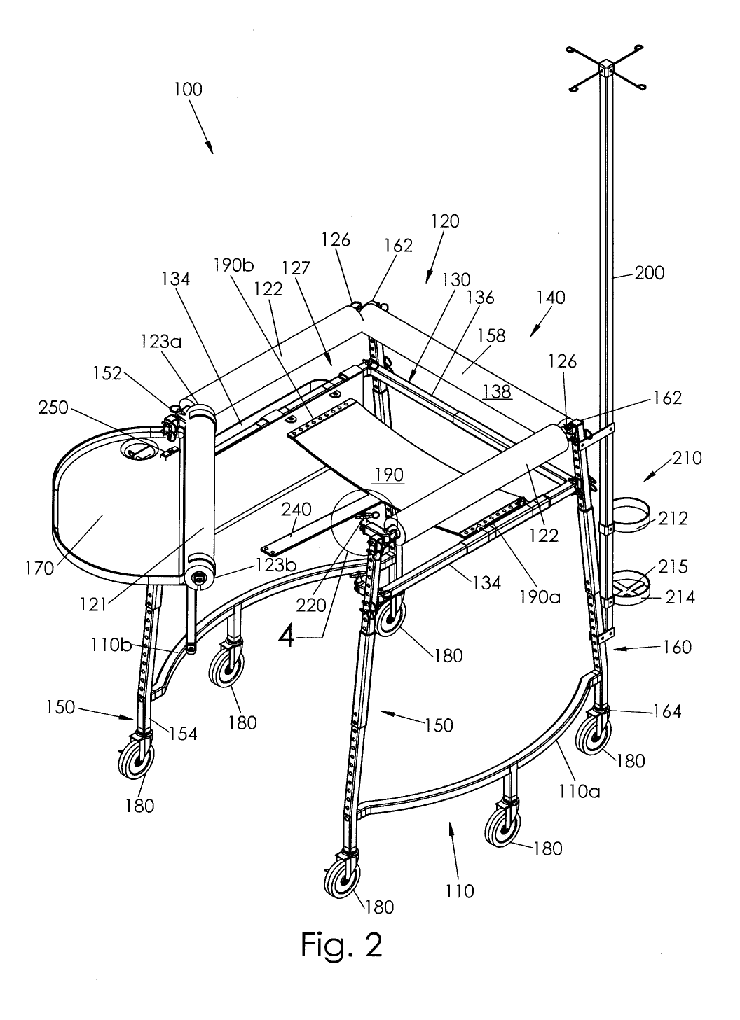

The upper section 120 includes a front member 121 (also referred to as an “upper section front member” for clarity) pivotally coupled at a proximal end 123a to one front support member upper end 152 and releasably coupled at a distal end 123b to the other front support member upper end 152 so as to be selectively movable between an open configuration (FIG. 1) and a closed configuration (FIG. 2). At the open configuration, a patient is able to move selectively into or out of the upper section interior area 127. By contrast, at the closed configuration the patient is prevented from selectively moving into or out of the upper section interior area 127. It is specifically noted that the patient does not have any trip hazard while moving in or out of the interior area 127 as the lower section 110 as the lower section 110 is specifically configured with a void area between the pair of front support members 150 (FIG. 2).

The upper section 120 may also include auxiliary support bars for added strength and stability. The auxiliary support bars 130 are displaced lowerly from the upper ends 152, 162 of respect front and rear support members 150, 160 but may otherwise be parallel to corresponding upper section front member 121, side member 122, and rear member 158. More particularly, a front auxiliary support bar 132 extends between the pair of front support members 150. Opposed side auxiliary side support bars 134 extend between respective front 150 and rear 160 support members. A rear auxiliary support bar 136 extends between rear support members 160.

Each of the upstanding support members 150, 160 is height/length adjustable. It is understood that each support member may include more height adjustment sections than described herein. More particularly, each front support member 150 includes a front support member lower section 150b and a front support member upper section 150a configured to slidably receive said front support member lower section 150b therein in a length adjustable configuration. The lower section 150b may define a plurality of spaced apart holes 150c and the upper section 150a may include a spring loaded fastener 150d configured to extend into a respective hole 150c when the lower section 150b is inserted into the upper section 150a.

Similarly, the rear support member 160 includes a rear support member lower section 150b and a rear support member upper section 160a configured to slidably receive said rear support member lower section 160b therein in a length adjustable configuration. The lower section 150b may define a plurality of spaced apart holes 160c and the upper section 160a may include a spring loaded fastener 160d configured to extend into a respective hole 160c when the lower section 160b is inserted into the upper section 160a.

A plurality of wheels 180 may be coupled to respective lower ends 154, 164 of the front support members 150 and the rear support members 160. Additional wheels 180 may be coupled to the support bars 110a, 110b of the lower section 110. Preferably, each of the wheels 180 is a castor wheel so that multi-directional movement is easily attained.

A tray 170 may be releasably coupled to the front support member 121 of the upper section 120. A seat member 190 having opposed first 190a and second ends 190b is operatively coupled by its ends to respective side auxiliary support members 134 and extends therebetween. A crotch strap 240 may be coupled to the seat member 190 and a front auxiliary support member 132 may be utilized to secure a patient to the seat member 190.

An IV pole 200 may be coupled to one rear support member 160 and extends upwardly therefrom. A tank holding assembly 210 may be coupled to the IV pole 200, the tank holding assembly 210 including a first support ring 212 and a second support ring 214, the second support ring 214 having a bottom 215 to support a compressed air tank in an upright position within the first support ring 212.

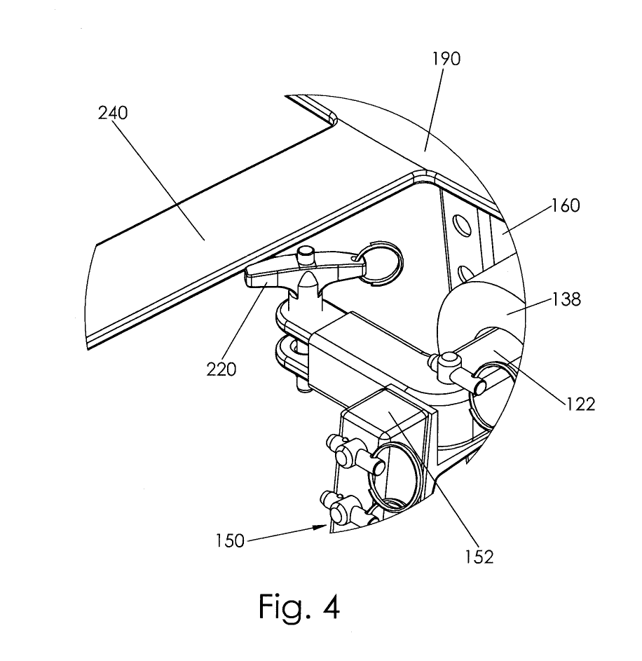

The walker apparatus 100 also includes a quick release pin 220 operatively coupled to an upper end 152 of a respective front support member 150 and configured to selectively hold or release the front support member 121. As shown in FIG. 4, the quick release pin 220 is configured to selectively secure the walker apparatus 100 in a closed configuration (FIG. 1) or to enable a user to release the front support member 121 to the open configuration (FIG. 2). At the open configuration, a patient is able to move into the interior area 127 of the upper section 120 while at the closed configuration, the patient is not able to move therebetween.

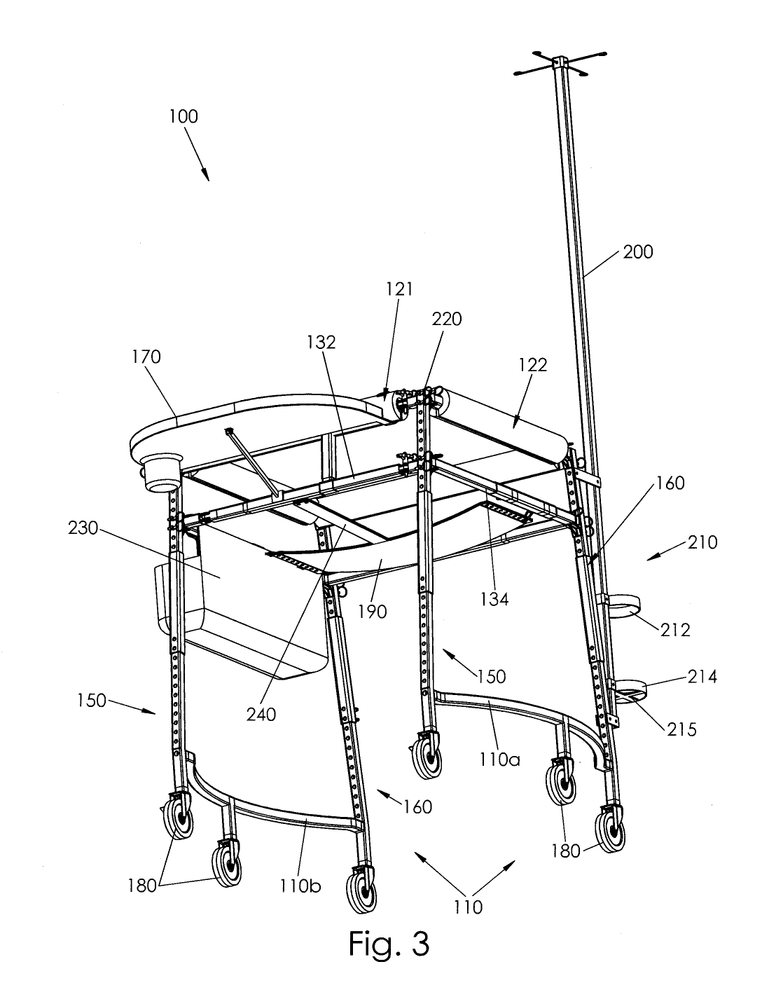

As shown in FIG. 3, the walker apparatus 100 may include a pocket 230. The pocket 230 may be coupled to a first auxiliary side 134a of the upper section 120. The pocket 230 may be constructed of a flexible material such as cloth and include an opening and interior area configured to hold papers, glasses, or other articles for the patient's use.

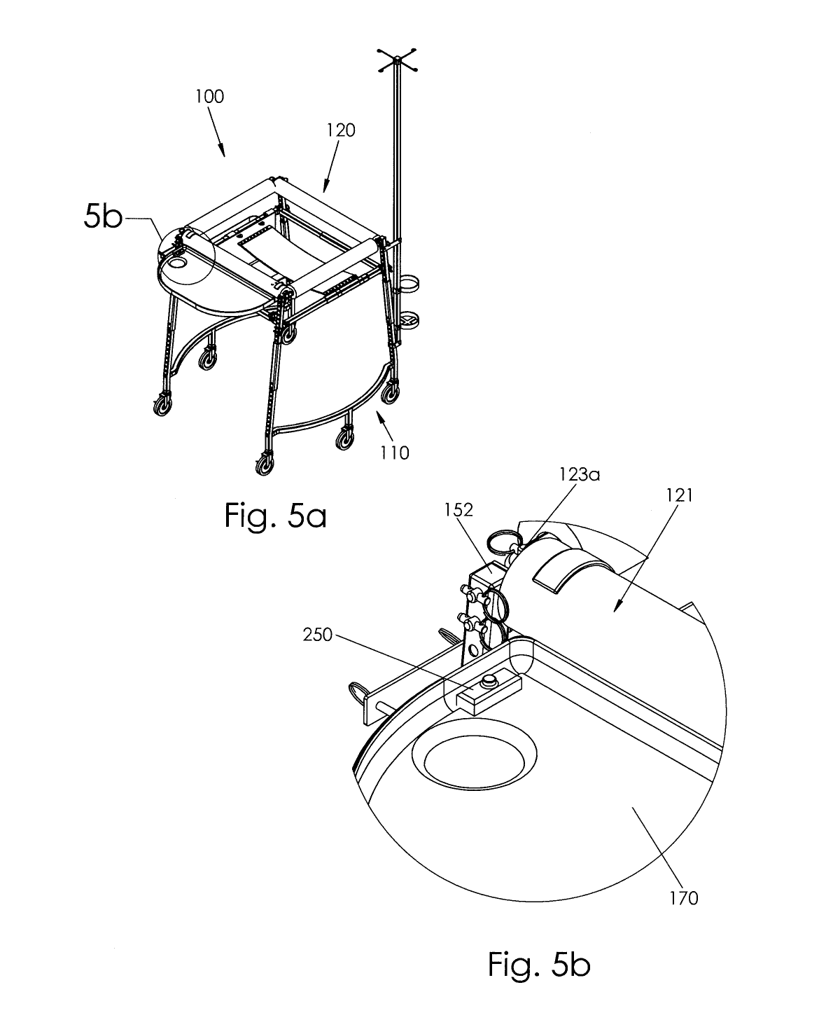

As shown in FIG. 5b, the walker apparatus 100 includes an emergency call device 250. The emergency call device 250 may be coupled on the tray 170 and can be selectively actuated to transmit an emergency signal into the air as needed. It is understood, of course, that the emergency call device 250 may be positioned at other locations on the framework 140.

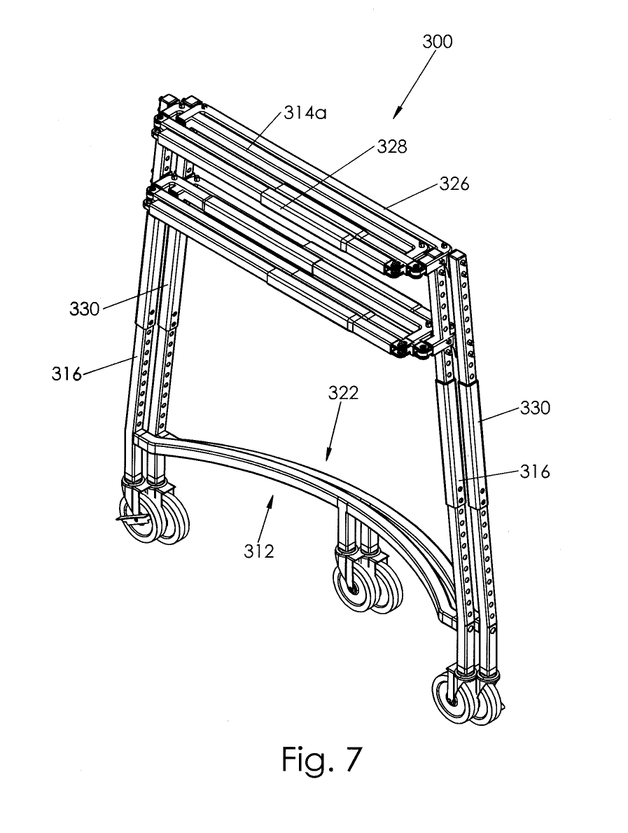

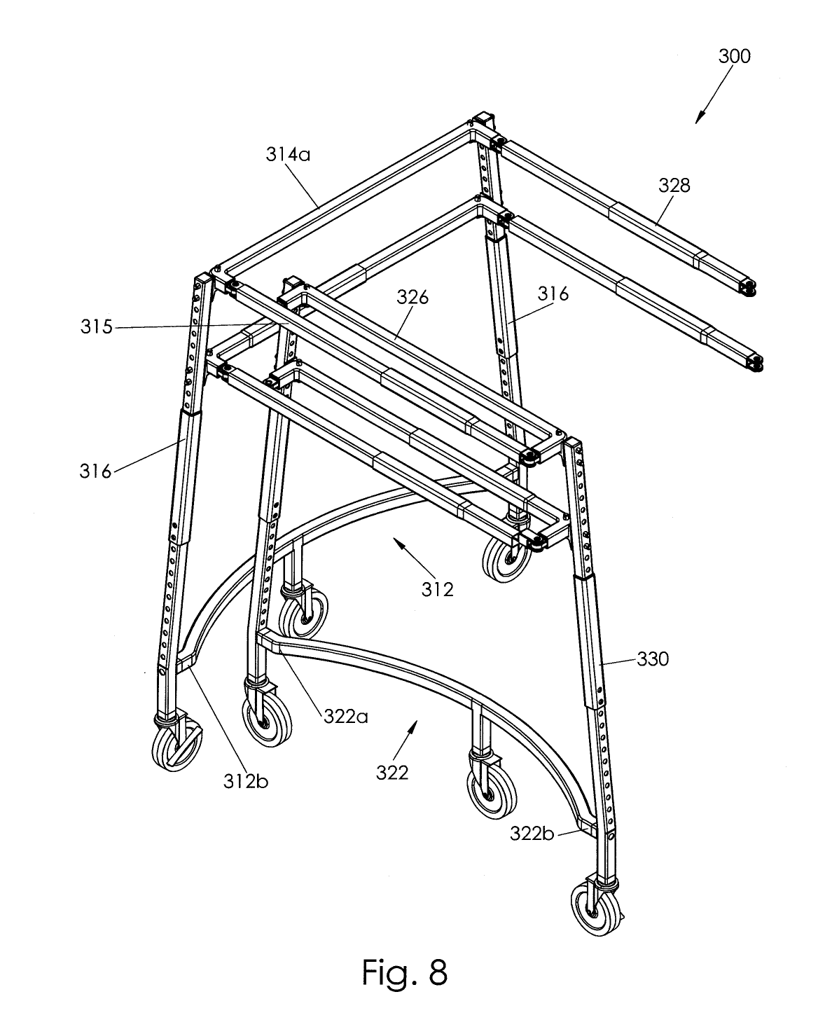

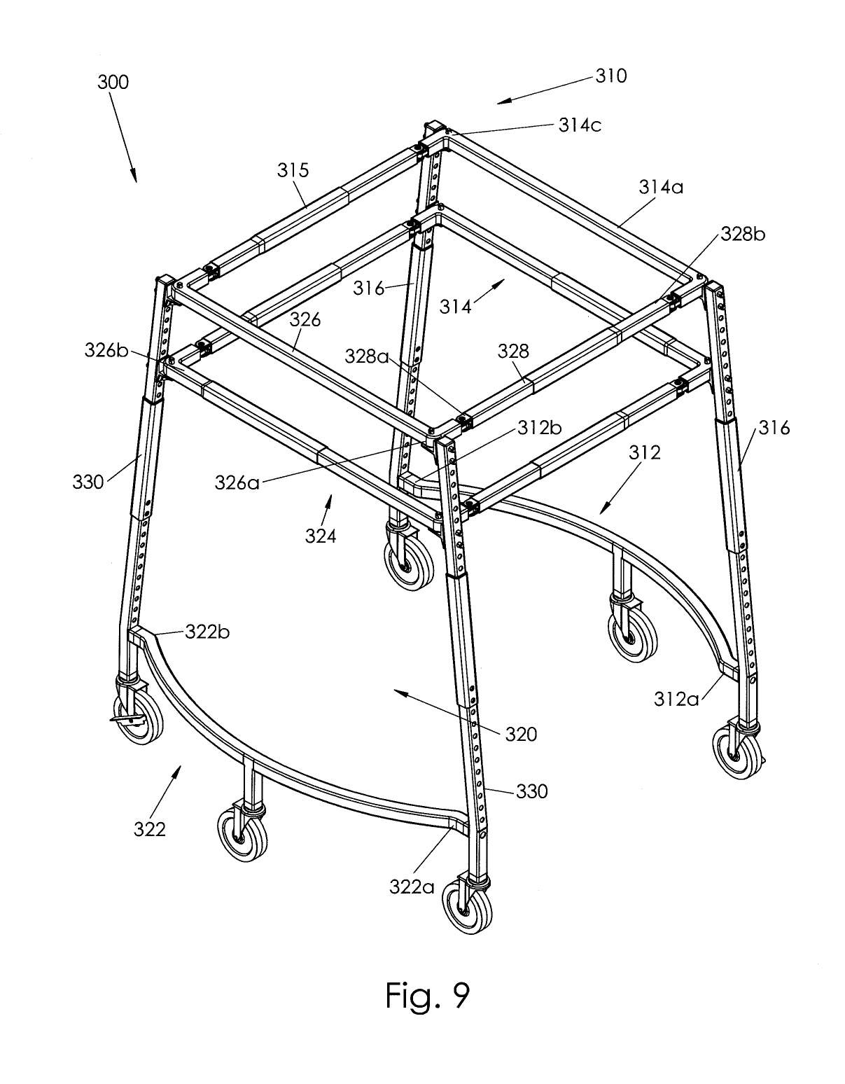

Another embodiment of the walker apparatus 300 is shown in FIG. 7 and includes a construction substantially similar to that described previously except as described specifically below. To best understand the alternative embodiment, the description will refer to a first side assembly 310 and a second side assembly 320, each assembly having lower and upper sections as described above.

The first side assembly 310 includes a first side lower section 312 having opposed first end 312a and second end 312b, the first side lower section 312 each having an outwardly arcuate configuration. The first side assembly 310 also includes a first side upper section 314 having a first side member 314a and a rear member 315 pivotally coupled to a rear end 314c of the first side member 314a. The first side assembly 310 includes a pair of upstanding first side support members 316 extending between the first side lower section first and second ends 312a, 312b and opposed ends 314b, 314c of the first side member 314a.

The second side assembly 320 includes a second side lower section 322 having opposed first end 322a and second end 322b, the second side lower section 322 having an outwardly arcuate configuration. The second side assembly 320 also includes a second side upper section 324 having a second side member 326 and a front member 328 having a proximal end 328a pivotally coupled to a front end 326a of the second side member 326 and a distal end 328b releasably coupled adjacent a front end 314b of the first upper section first side member 314a. The front member 328 of the second side upper section 324 is selectively movable between a closed configuration when the front member distal end 328b is coupled adjacent the front end 314b of the first side member 314a and an open configuration when the distal end 328b of the front member 328 is uncoupled and displaced from the front end 328b of the first side member 314a. The second side assembly 320 includes a pair of upstanding second side support members 330 extending between the second side lower section first and second end 322a and opposed ends 326a, 326b of the second side member 326. The first side assembly 310 can be selectively releasable from the second side assembly 320 and can be collapsible to facilitate storage.

The structures described above result in important functionality that makes the walking apparatus 310 desirable for use with patients, the elderly, and the disabled. The first end 312a of the first side lower section 312 and the first end 322a of the second side lower section 322 define a void 350 therebetween to prevent obstruction to a user moving between an area 352 between the first side assembly 310 and the second side assembly 320 and an area 354 outside of the first side assembly 310 and the second side assembly 320. In addition, pivotal coupling of key components makes the walker apparatus 310 easy to collapse and store. More particularly, the first side assembly upper section 314 includes a side member 314a pivotally coupled to a side member rear member 318. This enables the rear member 318 to fold in or collapse to a storage configuration as shown in FIG. 7. Similarly, the second side assembly upper section includes a side member 326 pivotally coupled to a front member 328—again allowing a selective folding or collapsing movement to a storage configuration as shown in FIG. 7. Further, the distal end 328c of the front member 328 is releasably coupled to the front end 326a of the second side member 326, allowing for selective movement between open and closed configurations.

The support members 316, 330 of the first and second side assemblies are length/height adjustable in the same manner as described above with reference to the support members 150 and 160. Likewise, the walker apparatus 300 may also include a seat member, crotch strap, emergency call device, wheels, etc., as the embodiment first described above even though not described again here.

In use, the walker apparatus enables a patient to walk, roll, sit to rest or eat, and transfer to and from a toilet with a decreased risk of falling and with an increased sense of convenience and independence. The walker apparatus can be configured to enable a user to operate a front gate between open and closed configurations and to enter and exit the apparatus without any trip hazards. The walker apparatus also has structures for holding a patient's compressed gas tank, IV pole, and personal items.

It is understood that while certain forms of this invention have been illustrated and described, it is not limited thereto except insofar as such limitations are included in the following claims and allowable functional equivalents thereof.

1. A walker apparatus for use with a patient having limited mobility, comprising:
a pair of spaced apart upstanding front support members, each front support member having upper and lower ends;
a pair of spaced apart upstanding rear support members, each rear support member having upper and lower ends;
an upper section mounted to respective upper ends of said pair of front support members and to respective upper ends of said pair of rear support members, said upper section defining an upper section interior area;
wherein:
said upper section includes a pair of opposed side members, each side member having a front end coupled to a respective front support member upper end and a rear end coupled to a respective rear support member upper end and extending therebetween;
said upper section includes an upper section rear member extending between said rear ends of respective upper section side members;
said upper section includes an upper section front member having a proximal end pivotally coupled to a respective front support member upper end and releasably coupled to another respective front support member upper end, such that said upper section front member is movable between an open configuration allowing the patient to move selectively into or out of said upper section interior area and a closed configuration preventing the patient from moving selectively into or out of said upper section interior area; and
a lower section mounted to respective lower ends of said pair of front support members and to respective lower ends of said pair of rear support members;
wherein:
said lower section includes a lower section first support bar and an opposed lower section second support bar, said first and second support bars each having an outwardly arcuate configuration extending between a respective front support member and a respective rear support member;
said lower section defines a void between said lower ends of respective front support members so as to allow the patient to move selectively into or out of said upper section interior area when said upper section front member is at said open configuration without any impediment by said lower section.

2. The walker apparatus according to claim 1, wherein said upper section front, side, and rear members include padding.

3. The walker apparatus according to claim 1, wherein said first end of said first side lower section and said first end of said second side lower section define a void therebetween to prevent obstruction to a user moving between an area within said upper section interior area and an area outside of said upper section interior area.

4. The walker apparatus according to claim 1, wherein each lower section side member has an outwardly arcuate configuration.

5. The walker apparatus according to claim 1, wherein said lower section first support bar and said lower section second support bar have an outwardly arcuate configuration.

6. The walker apparatus according to claim 1, further comprising a tray releasably coupled to said upper section front member, said tray extending outwardly from said upper section front member.

7. The walker apparatus according to claim 1, further comprising a plurality of wheels coupled to said lower ends of said front support members and said rear support members.

8. The walker apparatus according to claim 7, wherein each of said plurality of wheels is a castor wheel.

9. The walker apparatus according to claim 1, further comprising a seat member having opposed first and second ends operatively coupled to said opposed upper section side members and extending therebetween.

10. The walker apparatus according to claim 1, further comprising a quick release pin situated to selectively hold upper section front member at said closed configuration.

11. The walker apparatus according to claim 1, further comprising an elongate IV pole coupled to said rear support member and extending upwardly.

12. The walker apparatus according to claim 6, further comprising an emergency call device situated on said tray and configured to selectively transmit an emergency signal into the air.

13. The walker apparatus according to claim 1, further comprising a tank holding assembly coupled to said IV pole, said tank holding assembly having a first support ring and a second support ring, said second support ring having a bottom to secure a compressed air tank in an upright position within said first support ring.

14. The walker apparatus according to claim 9, further comprising a crotch strap coupled to said seat and configured to selectively secure the patient to said seat.

15. The walker apparatus according to claim 1, further comprising a pocket operatively coupled to said upper section, said pocket having an open end configured to receive articles into a pocket interior area.

16. The walker apparatus according to claim 1, wherein:
each front support member is length adjustable, said each front support member having a front support member lower section and a front support member upper section configured to slidably receive said front support member lower section therein in a length adjustable configuration; and
each rear support member is length adjustable, said each rear support member having a rear support member lower section and a rear support member upper section configured to slidably receive said rear support member lower section in a length adjustable configuration.

17. A walker apparatus for use with a patient having limited mobility, comprising:
a first side assembly, including:
a first side lower section having opposed first and second ends, said first side lower section having an outwardly arcuate configuration;
a first side upper section having a first side member and a rear member pivotally coupled to a rear end of said first side member;
a pair of upstanding first side support members extending between said first side lower section first and second ends and opposed ends of said first side member;
a second side assembly, including:
a second side lower section having opposed first and second ends, said second side lower section having an outwardly arcuate configuration;
a second side upper section having a second side member and a front member having a proximal end pivotally coupled to a front end of said second side member and a distal end releasably coupled adjacent a front end of said first side upper section first side member;
wherein said front member of said second side upper section is movable between a closed configuration when said front member is coupled adjacent said front end of said second side member and an open configuration when said front end of said second side member is uncoupled and displaced from said front end of said second side member;
a pair of upstanding second side support members extending between said second side lower section first and second end and a opposed ends of said second side member;
wherein respective first side support member and said second side support member define a void therebetween so that the patient is not obstructed from moving therebetween when said front member is at said open configuration; and
a plurality of wheels coupled to said first side lower section and said second side lower section.

18. The walker apparatus as in claim 17, wherein each said upstanding first side support members is length adjustable and each said upstanding second side support member is length adjustable.

19. The walker apparatus according to claim 17, wherein said first side assembly is selectively releasable from said second side assembly and collapsible to a storage configuration.

20. The walker apparatus according to claim 17, wherein each of said plurality of wheels is a castor wheel.
